(19) United States
(12) Patent Application Publication
(10) Pub. No.: US 2012/0312401 A1
(43) Pub. Date: Dec. 13, 2012

(54) MULTIPLE CONNECTOR AND SYSTEM FOR MIXING-EROGATING SANITARY AND PURIFIED WATER COMPRISING SAID MULTIPLE CONNECTOR

(75) Inventors: Luigi Gioira, Oleggio Castello (IT); Marco Gioira, Oleggio Castello (IT)

(73) Assignee: GM RUBINETTERIE S.R.L., Oleggio Castello (IT)

(21) Appl. No.: 13/490,982

(22) Filed: Jun. 7, 2012

(30) Foreign Application Priority Data
Jun. 7, 2011 (IT) MI2011A001020

(51) Int. Cl. F16L 41/00; F16L 15/00; E03C 1/044

(52) U.S. Cl. 137/603; 285/125.1

(57) ABSTRACT

A multiple connector for piping comprises a body provided with:
a first connection and passage portion suitable for coupling along a first axis with a first duct for the passage of a fluid,
a second connection and passage portion suitable for coupling along a second axis with a second duct for the passage of said fluid, and
a third connection and passage portion suitable for coupling along a third axis with a third duct for the passage of said fluid.

The first, second and third connection and passage portions are mutually arranged so that the first axis, the second axis and the third axis are mutually parallel.

The present invention relates to a multiple connector and to a system for mixing-delivering sanitary and/or purified water comprising such a multiple connector. The multiple connector according to the invention is suitable for being used for tubes or water piping for domestic usage, particularly for connecting a mixing-delivering valve group and a unit for treating the water with a hydraulic network. The treating unit can comprise a filtering unit for food use water, possibly including a device for cooling and/or gassing and/or heating to a temperature near to 100° C. said water.

In the State of the Art, a system is known for selectively delivering cold, hot and mixed sanitary water, and also purified water, possibly gassed by means of carbon dioxide. Said system comprises a valve group provided with a mixing tap for mixing cold and hot sanitary water supplied by a hydraulic network, and a control tap for delivering purified sanitary water, possibly gassed and/or cooled, flowing from a treating unit which is arranged for filtering, gassing and/or cooling the water.

The connection of the treating unit within said system is obtained upwardly to the valve group by providing a proper “T-shaped” pipe coupling and a ball valve suitable for stopping the flow in the same piping that is connected with the hydraulic network.

The “T-shaped” pipe coupling, also indicated in hydraulics with the term of “pipe tee” or “tee”, comprises a pipe body provided with three connection branches, mutually arranged according to a configuration having just the shape of a “T”. Each branch defines at its interior a respective passage cavity for the water and is internally provided with a thread of female type for the connection with a respective tube, provided, at one end thereof, with a threaded portion of male type. In particular, the “T-shaped” pipe coupling comprises a first passage cavity, suitable for receiving at the inlet the cold water provided by the hydraulic network via an inlet tube, a second passage cavity, enabling to deliver the cold water towards the valve group via a first outlet tube, and a third passage cavity, enabling the cold water to reach the treating unit via a second outlet tube.

The first passage cavity and the second passage cavity are axially aligned to each other, in other words the first passage cavity and the second passage cavity extend along a same first axis, whereas the third passage cavity extends along a second axis, perpendicularly arranged with respect to the first axis. In other words, in the coupling configuration of the “T-shaped” pipe coupling with the three tubes, the inlet tube results axially aligned, at least near the pipe coupling, with the first outlet tube, whereas the second outlet tube is perpendicularly arranged with respect to the inlet tube and the first outlet tube.

Such a configuration of the “T-shaped” pipe coupling often involves some mounting difficulties. In particular, the connections of the different tubes with the “T-shaped” pipe coupling result somewhat arduous and uncomfortable to be carried out, particularly when the spaces available for mounting are quite reduced.

An object of the invention is to improve the known systems for selectively delivering both cold, hot and mixed sanitary water and purified water for food usage, possibly treated by gassing, and/or cooled and/or made boiling. In particular, an object of the invention is to provide an economical solution, capable of simplifying and speeding up the connection between hydraulic network, valve group and treating unit, and simultaneously capable of reducing the space occupied, required for mounting the different parts of the system.

Owing to the multiple connector according to the invention, all the drawbacks implied in the systems and the “T-shaped” pipe couplings described above are solved.

Features and advantages of the present invention will better result from the following description and the enclosed drawings that illustrate an exemplifying and not limitative embodiment, wherein:

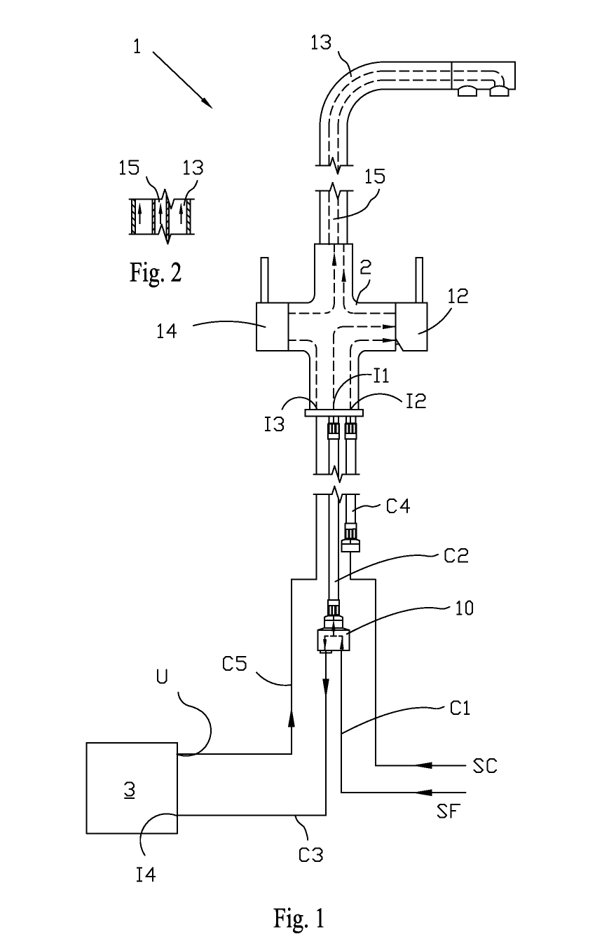

FIG. 1 is a partially schematic view of a system suitable for mixing-delivering cold, hot or mixed sanitary water and purified and gassed and/or cooled or heated water, wherein a multiple connector according to the invention is provided;

FIG. 2 is an enlarged, longitudinal cross sectional view of the system of FIG. 1;

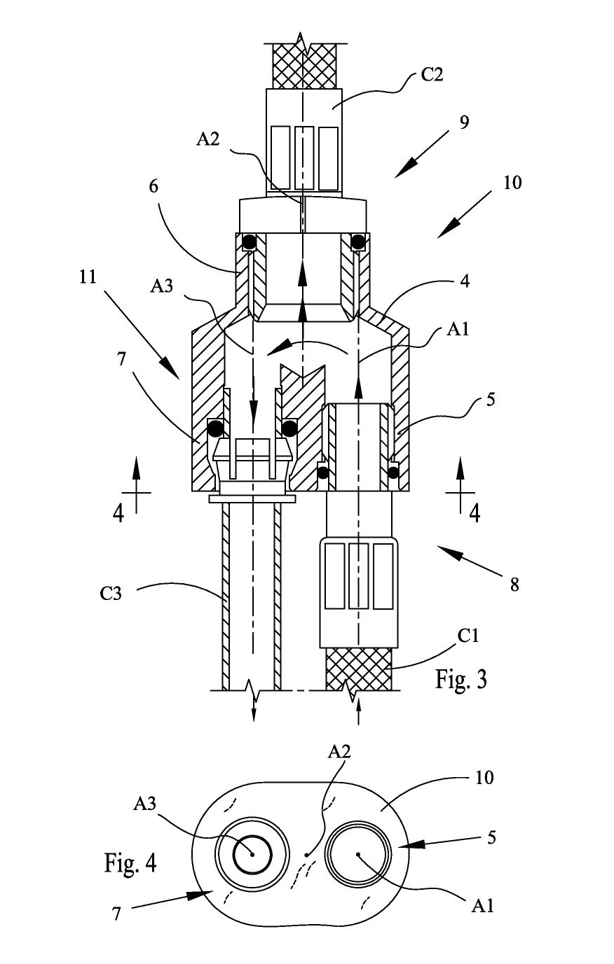

FIG. 3 is an enlarged, longitudinal cross sectional view of the multiple connector according to the invention that is included in the system of FIG. 1;

FIG. 4 is a view according to line 4-4 of FIG. 3;

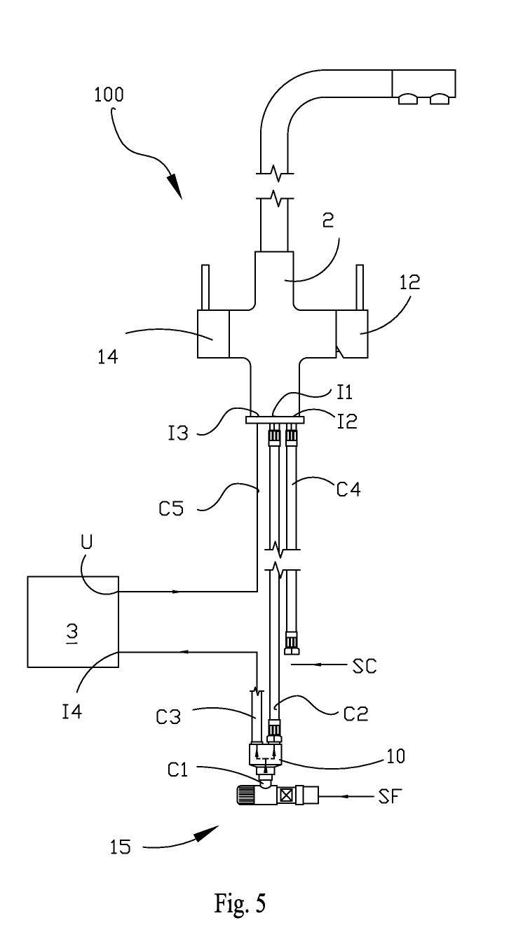

FIG. 5 is a view of a mixing-delivering system similar to the system of FIG. 1, wherein, however, the multiple connector according to the invention is arranged according to a different mounting configuration.

With reference to FIG. 1, a system 1 for selectively delivering cold, hot and mixed sanitary water is shown, in an exemplifying and not limiting way, which system 1 is suitable as well for selectively delivering purified water for food usage, with possible gassing by means of carbon dioxide, and/or cooled and/or boiling water, i.e. water at a temperature near to 100° C. The system 1 comprises a valve group 2 for delivering sanitary water and purified water, and a unit 3 for treating the water, the unit 3 having the function of filtering, and possibly gassing, by means of addition of carbon dioxide, and/or cooling and/or carrying to a temperature near to 100° C., or about 90° C. or, i.e. slightly higher or lower than 90° C., the water provided by the hydraulic network.

In particular, the valve group 2 comprises a mixing tap 12, for selectively supplying cold, hot or mixed sanitary water to a first delivering tubular duct 13; the valve group 2 further comprises a control tap 14 for controlling the flow of water treated and provided by the treating unit 3, which water is delivered by a second tubular duct 15, that is parallel or internal to the first delivering duct 13.

The system 1 comprises a multiple connector 10 according to the invention, which will be described in detail in the following. The multiple connector 10 is connected, by means of a first duct C1, with a source SF of cold sanitary water, making part of a conventional hydraulic network, and is connected at the same time, via a second duct C2, with the valve group 2, in order to deliver cold water, flowing from said source SF, to said valve group 2.

The multiple connector 10 is further connected, via a third duct C3, with the unit 3 for treating the water, in order to deliver cold water, flowing from the source SF, to said treating unit 3.

The valve group 2 is connected, via a fourth duct C4, with a source SC of hot water, delivered for example by a heating system, or a wall boiler, or a tank of hot water.

A first inlet port I1 for the mixing tap 12 can receive the cold water flowing through the second duct C2 from the multiple connector 10. A second inlet port 12 for the mixing tap 12 can receive the hot water flowing through the fourth duct C4. A third inlet port I3 for the control tap 14 can receive the treated water flowing from the treating unit 3 through a fifth duct C5. In other words, the cold water, reaching a fourth inlet port I4 of the unit 3 through the third duct C3, once treated, exits from the unit 3 through an outlet port U in order to reach the third inlet port I3 of the valve group 2, in particular in order to reach the control tap 14.

The multiple connector 10, according to the invention that is used in the system 1 disclosed above, is now described more in detail, with reference to the mounting configuration of FIG. 1.

As better shown in FIG. 3, the multiple connector 10 comprises a body 4 provided, at a first end 8, with a first connection and passage portion 5, suitable for coupling with a duct along a first axis A1. In the exemplifying embodiment of FIG. 1, the first connection and passage portion 5 is coupled with the first duct C1 in order to receive the cold water provided by the source SF of the hydraulic network.

The first connection and passage portion 5 defines at its interior a first passage cavity for the water, which first passage cavity at least partially extends along the first axis A1.

The body 4 of the multiple connector 10 comprises, at a second end 9 opposite the first end 8, a second connection and passage portion 6, suitable for coupling with a duct along a second axis A2. In the exemplifying embodiment of FIG. 1, the second connection and passage portion 6 is coupled with the second duct C2 in order to deliver the cold water provided by the source SF of the hydraulic network to the valve group 2.

The second connection and passage portion 6 defines at its interior a second passage cavity for the water, which second passage cavity at least partially extends along the second axis A2.

The body 4 of the multiple connector 10 further comprises, at the first end 8, a third connection and passage portion 7, suitable for coupling with a duct along a third axis A3. In particular, the third connection and passage portion 7 is coupled with the third duct C3 in order to deliver the cold water provided by the source SF of the hydraulic network to the treating unit 3. The third connection and passage portion 7 defines at its interior a third passage cavity for the water, which third passage cavity at least partially extends along the third axis A3. The first, second and third passage cavities are in fluid communication to each other. Consequently, the cold water coming from the cold source and entering the multiple connector 10 through the first portion 5, can flow both into the second connection and passage portion 6 and into the third connection and passage portion 7, in order to reach the mixing tap 12 and/or the treating unit 3 respectively.

The first connection and passage portion 5, the second connection and passage portion 6 and the third connection and passage portion 7 are mutually arranged to each other so that the first axis A1, the second axis A2 and the third axis A3 are mutually parallel. In particular, the second connection and passage portion 6 is arranged with respect to the first connection and passage portion 5 and the third connection and passage portion 7 so that the second axis A2 results interposed between the first axis A1 and the third axis A3. Owing to this configuration, the multiple connector 10 results more compact with respect to the already known conventional “T-shaped” pipe couplings, and consequently said multiple connector 10 enables, i.a., to remarkably reduce the space requirements of the system. The fact that the first connection and passage portion 5, the second connection and passage portion 6, and the third connection and passage portion 7 extend along axes that are parallel to each other, enables the different connection and passage ducts for the water to be maintained arranged parallel to a same direction, where possible at least near to the multiple connector 10, without the need of imposing large curvatures and changes of direction to the ducts—which large curvatures and changes of direction are conversely unavoidable with the conventional “T-shaped” pipe couplings—especially in the case that very reduced spaces are available.

The first duct and the second duct comprise a first flexible tube C1, or a first copper tube, and a second flexible tube C2, or a second copper tube, respectively. The first connection and passage portion 5 and the second connection and passage portion 6 are configured for the threaded coupling with the first flexible tube C1 and the second flexible tube C2 respectively. In particular, the first portion 5 and the second portion 6 are provided with respective female threaded joints, having the size for example of ⅜″. Other dimensions can also be provided for enabling tubes of different size to be connected, according to the pitch of the screw thread used (M8X1, M10X1, M12X1 etc.).

The third connection and passage portion 7 is configured for coupling, by means of a quick coupling joint 11, with the third duct C3, that in this case can be a tube C3 of plastic material with diameter of different sizes, for example 8 mm.

Owing to the so configured multiple connector 10, the connecting operations carried out by a specialized worker assigned to install the system are remarkably simplified and speeded up, particularly owing to the presence of the quick coupling joint 11, that enables the difficulties to be avoided, that arise on the contrary when using the conventional “T-shaped” pipe couplings.

In FIG. 5 a system 100 is shown that is both structurally and functionally similar to the system 1 previously described. Consequently, for the system 100 the same reference numbers of FIG. 1 are used, in order to indicate similar or equivalent parts. The system 100 of FIG. 5 differs from the embodiment of FIG. 1 in that the multiple connector 10 is positioned according to a mounting configuration different from the mounting configuration previously described. In particular, the multiple connector 10 is positioned so that the second connection and passage portion 6 receives at the inlet the cold water provided by the hydraulic network. In particular, the first duct C1 can comprise in this case an under-sink unit 15. The first connection and passage portion 5 is coupled with the second duct C2 in order to deliver the cold water provided by the hydraulic network to the valve group 2.

The third connection and passage portion 7 is coupled with the third duct C3 in order to deliver the cold water provided by the hydraulic network to the treating unit 3. The fourth duct C4 connects the valve group 2 directly with the source SC of hot water, similarly as shown for the embodiment of the system 1. From the comparison of the two different mounting configurations shown in FIG. 1 and FIG. 5, it is clear that the multiple connector 10 results very versatile and suitable for being employed according to a plurality of modes of usage.

As already said, owing to the multiple connector 10, the space requirements can be reduced and a quick and safe connection can be obtained, owing to the presence of the quick coupling joint 11 and because flexible tubes and seals of the “O-ring” type of proven and remarkable reliability can be used respectively. In addition, advantages are obtained from the economic point of view, since there is no need to use pipe couplings of different type that increase the installation costs.

Variations and/or additions can be made to all was described above and was shown in the enclosed drawings.

1. Multiple connector for piping, comprising a body provided with:
a first connection and passage portion suitable for coupling along a first axis with a first duct for the passage of a fluid,
a second connection and passage portion suitable for coupling along a second axis with a second duct for the passage of said fluid, and
a third connection and passage portion suitable for coupling along a third axis with a third duct for the passage of said fluid,
wherein said first, second and third connection and passage portions, are mutually arranged so that said first axis, said second axis and said third axis are mutually parallel.

2. Multiple connector according to claim 1, wherein said first and said third connection and passage portions flow out at a first end of said body, whereas said second connection and passage portion flows out at a second end of said body opposing said first end.

3. Multiple connector according to claim 1, wherein said first connection and passage portion and said second connection and passage portion are configured for the threaded coupling with said first duct and said second duct respectively, and said third connection and passage portion is configured for coupling by means of a quick coupling joint with said third duct.

4. Multiple connector according to claim 3, wherein said first connection and passage portion and said second connection and passage portion are internally provided with a first female thread and a second female thread respectively for coupling with said first duct and said second duct respectively.

5. Multiple connector according to claim 1, wherein said first connection and passage portion, said second connection and passage portion and said third connection and passage portion extend with respect to each other so that said second axis results interposed between said first axis and said third axis.

6. Multiple connector according to claim 1, wherein said first connection and passage portion, said second connection and passage portion and said third connection and passage portion define at their interior respective passage cavities that are in fluid communication to each other.

7. Multiple connector according to any of claim 1, wherein said body together with said first connection and passage portion, said second connection and passage portion and said third connection and passage portion are made in one piece.

8. Multiple connector according to claim 1, wherein said first connection and passage portion is suitable for being connected with a hydraulic network in order to receive at the inlet water from said hydraulic network, said second connection and passage portion is suitable for being connected with a valve group in order to deliver at the outlet the water to said valve group, and said third connection and passage portion is suitable for being connected with a treating unit in order to deliver at the outlet the water to said treating unit, said treating unit comprising a filtering unit.

9. Multiple connector according to claim 1, wherein said second connection and passage portion is suitable for being connected with a hydraulic network in order to receive at the inlet the water from said hydraulic network, said first connection and passage portion is suitable for being connected with a valve group in order to deliver at the outlet the water to said valve group, and said third connection and passage portion is suitable for being connected with a treating unit in order to deliver at the outlet the water to said treating unit, said treating unit comprising a filtering unit.

10. System for selectively mixing-delivering sanitary water and purified water for food usage, comprising:
a mixing group for delivering cold, hot, and/or mixed sanitary water, and for delivering purified and possibly treated water,
a treating unit for said water and
a multiple connector according to claim 8, for connecting said mixing group and said treating unit with the hydraulic network.

11. System according to claim 10, wherein said treating unit comprises a filtering unit.

12. Multiple connector according to claim 8, wherein said treating unit is provided with a gassing and/or cooling heating device for heating to a temperature near to 100° C.

13. Filtering unit according to claim 12, provided with a device suitable for cooling, and/or gassing and/or heating to a temperature near to 100° C. said water.
